(19) United States
(12) Patent Application Publication
(10) Pub. No.: US 2025/0067557 A1
(43) Pub. Date: Feb. 27, 2025

(54) Method and Device for an Indirect Length Measurement

(71) Applicant: Robert Bosch GmbH, Stuttgart (DE)

(72) Inventors: Heinz Haeberle, Stuttgart (DE); David Kapfenberger, Stuttgart (DE)

(21) Appl. No.: 18/723,088

(22) PCT Filed: Dec. 12, 2022
(86) PCT No.: PCT/EP2022/085373

§ 371 Date: Jun. 21, 2024

(30) Foreign Application Priority Data
Dec. 30, 2021 (DE) 10 2021 215 102.7

(51) Int. Cl. G01B 11/14; G01S 7/48; G01S 7/497; G01S 17/08

(52) U.S. Cl. CPC G01B 11/14; G01S 7/4808; G01S 7/497; G01S 17/08

(57) ABSTRACT

The disclosure relates to a method for indirectly measuring the length of the distance between a measurement point and an additional measurement point using a distance measuring device of a handheld length measuring device wherein in at least one measurement step, the distance between the distance measuring device and the measurement point is detected in a measurement position of the distance measuring device, and in at least one additional measurement step, an additional distance between the distance measuring device and the additional measurement point is detected in an additional measurement position of the distance measuring device. According to the disclosure, in at least one method step, the distance between the measurement point and the additional measurement point is ascertained as a function of at least one body model parameter of a user of the length measuring device.

### PRIOR ART

A method for the indirect length measurement of a distance between a measurement point and an additional measurement point using a distance measuring device of a handheld length measuring device has already been proposed, wherein in at least one measurement step, the distance between the distance measuring device and the measurement point is detected in a measurement position of the distance measuring device, and in at least one additional measurement step, an additional distance between the distance measuring device and the additional measurement point is detected in an additional measurement position of the of the distance measuring device.

### DISCLOSURE OF THE INVENTION

The invention relates to a method for the indirect length measurement of the distance between a measurement point and an additional measurement point using a distance measuring device of a handheld length measuring device, wherein in at least one measurement step of the method, the distance between the distance measuring device and the measurement point is detected in a measurement position of the distance measuring device, and in at least one additional measurement step of the method, an additional distance between the distance measuring device and the additional measurement point is detected in an additional measurement position of the distance measuring device.

According to the invention, in at least one method step, the distance between the measurement point and the additional measurement point is ascertained as a function of at least one body model parameter of a user of the length measuring device. In particular, the length measuring device comprises a computing unit that calculates the distance between the measurement points as a function of the ascertained distance and the ascertained additional distance. The distance measuring device preferably uses a time-of-flight to detect the distance and/or the additional distance. Particularly preferably, the distance measuring device transmits light waves, in particular light beams, preferably laser beams or infrared beams, or radio waves to perform the time-of-flight measurement. Preferably, a user aims at the measurement point with the distance measuring device to detect the distance and/or the additional measurement point to detect the additional distance. In particular, when aiming at the measurement point, the user aligns the distance measuring device and thereby defines the measurement position. In particular, when aiming at the additional measurement point, the user aligns the distance measuring device and thereby defines the additional measurement position. The measurement position and the additional measurement position are ascertained in particular when the distance measuring device is triggered. The triggering of the distance measuring device is preferably done manually. Alternatively or additionally, the distance measuring device comprises at least one operating mode for automatically triggering the distance measuring device, for example, as a function of machine detection of edges of a measurement object or the like, by the length measuring device.

Particularly preferably, the computing unit additionally calculates the distance as a function of the measurement position and the additional measurement position. The measurement position and the additional measurement position differ in particular by a spatial location, for example given by coordinates of a reference point of the distance measuring device, and/or a spatial orientation, for example given by angular information of a reference axis, in particular a main beam direction, of the distance measuring device. The additional measurement position differs in particular from the measurement position, in particular due to translation and/or rotation of the distance measuring device by the user, in particular to align the distance measuring device with the additional measurement point starting from the measurement point. Preferably, at least the distance measuring device, in particular the entire length measuring device, is guided by the user on the body of the user during the measurement step and between the measurement steps, in particular in one hand, in particular in a single hand, of the user. Particularly preferably, at least the distance measuring device, in particular the entire length measuring device, is freely movable relative to the measurement point and the additional measurement point.

Preferably, the computing unit uses the body model parameter to describe a change in position of the distance measuring device from the measurement position to the additional measurement position carried out by the user. In particular, the computing unit ascertains the additional measurement position relative to the measurement position as a function of the body model parameter. The body model parameter preferably describes a body dimension, for example a body size, an arm length or the like, and/or a body posture value, for example a degree of extension or flexion of an arm, a degree of rotation of a shoulder girdle, a degree of rotation of an upper body or the like, of the user during the measurement step, the additional measurement step, and/or between the measurement steps. The body model parameter may in particular be identical to the body dimension or body posture value or may be ascertained as a function of the body dimension and/or body posture value. The body model parameter is in particular a parameter of a model of a user's body, which approximately describes the body dimension or body posture value of a real user's body. The body model parameter may be non-specific, group-specific, or person-specific. A non-specific body model parameter is ascertained in particular in advance of the method as a mean value or median of body model parameters of a plurality of, in particular randomly selected, people and stored in particular in a memory of the computing unit. A group-specific body model parameter is ascertained in particular in advance of the method as a mean value or median of body model parameters of a plurality of people, which were selected on the basis of at least one characteristic, and is stored in particular in a memory of the computing unit. For example, the group-specific body model parameter is gender-specific, country-specific or region specific, location-specific, or the like. Optionally, the memory of the computing unit stores a plurality of group-specific body model parameters, from which a user can select via a control unit of the length measuring device. The person-specific body model parameter is ascertained in particular in advance of the method as a function of the body dimension or body posture of a single user and is in particular stored in a memory of the computing unit.

The distance can advantageously be ascertained precisely by means of the embodiment according to the invention. In particular, handling of the length measuring device by the user may be considered at least approximately when ascertaining the distance. In particular, a sensor technology for detecting the change in position can advantageously be kept simple. In particular, the length measuring device can be advantageously implemented cost-effectively.

It is further proposed that the body model parameter corrects the detected distance and/or the detected additional distance to determine the distance between the measurement point and the additional measurement point. In particular, the body model parameter extends the detected distance and/or the detected distance. Particularly preferably, the computing unit adds the body model parameter to the distance and/or the additional distance. Optionally, the computing unit uses different body model parameters to correct the distance and correct the additional distance. In an advantageously simple embodiment, the computing unit uses the same body model parameter to correct the distance and correct the additional distance. For example, the computing unit calculates the distance based on a geometrical relationship of an intended geometrical figure, which includes the distance, the distance corrected with the body model parameter, and the additional distance corrected with the body model parameter. In particular, the body model parameter describes a distance of a reference point, in particular a zero point, of the distance measuring device from a body pivot axis of rotation or a body pivot point of a body of the user. In an advantageously simple embodiment, the geometric figure is a triangle formed from the three distances mentioned, wherein the corrected distances intersect in particular in a single body pivot point. In an alternative configuration or an alternative mode of operation of the length measuring device, the geometric figure is for example an, in particular planar or three-dimensional, quadrilateral, pentagon, or other polygon or polyhedron, which additionally comprises, for example, at least one distance between two different body pivot points and/or body pivot axes. In an advantageously simple embodiment, the change in position of the distance measuring device from the measurement position to the additional measurement position is preferably described by the computing unit by means of the body model parameter by pure rotation, i.e. in particular without a translational portion, about the body axis of rotation or the body rotation point. In an advantageously precise embodiment, the change in position of the distance measuring device from the measurement position to the additional measurement position is described by the computing unit by means of the body model parameter, in addition to a rotation about the body pivot axis or the body pivot point, by a translation of the distance measuring device towards or away from the body pivot axis or the body pivot point on the body pivot axis or body pivot point. The body pivot axis or the body pivot point may be a physical pivot axis or a physical pivot point, such as a user's joint, or an effective pivot axis, which results from the interaction of multiple physical pivot axes and/or pivot points. Due to the design according to the invention, a necessary computing power for consideration of a body model of the user can be kept advantageously low.

It is also proposed that at least one additional body model parameter is used in at least one method step of the method, to correct the detected distance and/or the detected additional distance, wherein a selection of which body model parameter is used and/or to what proportion the body model parameters are used, is dependent on a detection of a change in position of the distance measuring device from the measurement position to the additional measurement position. In particular, the computing unit uses the body model parameter and the additional body model parameter to describe the change in position due to multiple, in particular perpendicular, partial changes in position. Particularly preferably, the computing unit processes a horizontal partial change in position independent of a vertical partial change in position. For example, the computing unit corrects the distance and/or the additional distance with the body control parameter for describing the horizontal partial change in position, in particular for calculating a horizontal partial distance between the measurement point and the additional measurement point. For example, the calculation unit corrects the distance and/or the additional distance with the additional body control parameter for describing the vertical partial change in position, in particular for calculating a vertical partial distance between the measurement point and the additional measurement point. In particular, the computing unit calculates the distance from the horizontal partial distance and the vertical partial distance. Alternatively, the calculating unit calculates a body model parameter dependent on the change in position, which comprises, for example, a proportion of the body model parameter and/or a proportion of the additional body model parameter depending on a ratio of the partial change in position. The embodiment according to the invention advantageously makes it possible to further specify a body model of the user more easily, in particular with little additional computing effort.

It is further proposed that in at least one method step of the method, a pivot point, in particular the aforementioned body pivot point or the aforementioned body pivot axis, which describes a change in position of the distance measuring device from the measurement position to the additional measurement position and on which the body model parameter is dependent, is selected. In particular, a plurality of body model parameters are stored in the memory of the computing unit, which are in particular used for different measurement situations. For example, a body model parameter is stored in the memory, which describes a change in position of the distance measuring device, which is performed primarily by means of a wrist joint, primarily by means of an elbow joint, primarily by means of a shoulder joint or the like. Preferably, the computing unit evaluates the distance, the additional distance, a pre-calculation of the distance without use of the body model parameter, and/or a change in the orientation of the distance measuring device detected by an angle measuring device of the length measuring device to select one of the body model parameters. Alternatively, the computing unit calculates a value of the distance for a plurality of the body pivot points and/or body pivot axes and outputs it to the user via an output unit of the length measuring device. Alternatively, the user selects the body pivot point and/or the body pivot axis via the operating unit. By means of the embodiment according to the invention, an advantageously high ease of use can be achieved. In particular, the length measuring device can advantageously be used flexibly in different measurement situations.

Furthermore, the invention proceeds from a method for determining and outputting a measurement error for an indirect length measurement, in particular for an indirect length measurement as part of the aforementioned method for indirect length measurement. The method for determining and outputting a measurement error is in particular a partial method of the aforementioned method for indirect length measurement. The method for determining and outputting a measurement error is hereinafter referred to as the measurement error procedure to distinguish it from the method for indirect length measurement. It is proposed that in at least one method step of the measurement error method, the measurement error is ascertained and output as a function of at least one, in particular the aforementioned, body model parameter of a user of an, in particular the aforementioned, length measuring device used for the indirect length measurement. The measurement error in particular indicates a measurement uncertainty of the calculated distance. In particular, the measurement error is calculated from the computing unit. The measurement error is in particular calculated as the largest error. Preferably, the computing unit calculates the measurement error as a function of a structure of the length measuring device. The computing unit preferably takes into account an error factor due to a user behavior, for example due to the user shaking or the like, when calculating the measurement error. In particular, the calculation unit uses a distance measuring device error when detecting the distance and/or the additional distance, an angle measuring device error when detecting a change in the orientation of the distance measuring device and/or a body model parameter error to calculate the measurement error. Preferably, the output unit outputs the measurement error, in particular together with the ascertained distance. The measurement error may be output as an absolute value, a relative value, or encoded. An encoded output of the measurement error preferably at least indicates whether the measurement error is above or below at least one error threshold value. The measurement error may be encoded by charts, colors, (alert) symbols, or the like. As a result of the embodiment according to the invention, an advantageously accurate measurement error can be output. In particular, a situation-specific measurement error may be output. In particular, feedback can be provided to the user as to which measurement situations allow the distance to be determined with sufficient accuracy and which measurement situations lead to an insufficient determination of the distance.

It is further proposed that in at least one method step of the measurement error method, a proposal is output as to how the measurement error can be reduced. In particular, the proposal is output by the output unit. The proposal is output in particular if the measurement error is above the error threshold value. Optionally, the error threshold value may be changed by the user via the operating unit. For example, the proposal may be aimed at the user changing the distance and/or additional distance of the distance measuring device to the measurement points, in particular decreasing or increasing it. For example, the proposal may be aimed at the user changing his location so that the distance and the additional distance become more similar. For example, the proposal may be aimed at the user adopting a predefined posture during the change in position. For example, the proposal may be aimed at the user changing the body model parameter, in particular determining a person-specific body model parameter, or selecting another of the body model parameters stored in the memory unit. By means of the embodiment according to the invention, an advantageously high ease of use can be achieved.

Furthermore, the invention proceeds from a method for calibrating an, in particular the aforementioned, length measuring device, for an indirect length measurement, in particular for indirect length measurement according to the aforementioned method for indirect length measurement. The method for calibrating is in particular a partial method of the aforementioned method for indirect length measurement. The method for calibration is hereinafter referred to as the calibration method to distinguish it from the method for indirect length measurement. It is proposed that in at least one method step of the calibration method, an, in particular the aforementioned, body model parameter of a user of the length measuring device is ascertained. In particular, the person-specific body model parameter is detected in the calibration method. Particularly preferably, the user performs an indirect length measurement of a calibration distance with the length measuring device to ascertain the body model parameter. Alternatively or additionally, the user ascertains at least one body dimension and/or a body posture value by means of an, in particular additional, direct or indirect length measuring device, for example a measuring tape, a meter rule or the like, and enters this into the indirect length measuring device to be calibrated by means of the operating unit. In particular, the calculation unit adopts the entered body dimension and/or the entered posture value as a person-specific body model parameter or ascertains the person-specific body model parameter as a function of the entered body dimension and/or the entered posture value. As result of the embodiment according to the invention, the body model parameter can advantageously be adapted specifically to a user.

It is further proposed that in at least one method step of the calibration method, the body model parameters are ascertained by indirect length measurement of a known distance, in particular the aforementioned calibration distance, between two measurement points. The calibration distance is preferably set by a user. In particular, a distance of the distance measuring device from the measurement point in a measurement position of the distance measuring device is detected in at least one measurement step of the indirect length measurement method of the calibration method analogous to the measurement step of the method for indirect length measurement, wherein the measurement point limits the calibration distance. Preferably, an additional distance of the distance measuring device from the additional measurement point in an additional measurement position of the distance measuring device is detected in at least one additional measurement step of the indirect length measurement method of the calibration method analogous to the additional measurement step of the method for indirect length measurement, wherein the additional measurement point limits the calibration distance. In particular, the computing unit requests the value of the calibration distance limited by the measurement points from the user. For example, the user may detect the calibration distance by means of an, in particular additional, direct or indirect length measuring device, in particular a measuring tape or a meter rule. Alternatively, the computing unit or an operating manual of the length measuring device provides a value of the calibration distance, in particular by means of the output unit, which the user is to comply with for carrying out the measurement step and the additional measurement step. As result of the embodiment according to the invention, the body model parameter can advantageously be easily ascertained. In particular, a measurement of the body of the user may be omitted.

It is further proposed that in at least one method step of the calibration method, the body model parameters are ascertained as a function of multiple ascertained values of the known distance, in particular the aforementioned calibration distance. In particular, the computing unit ascertains a body model parameter for each detected calibration distance value. In particular, the computing unit stores a mean value or median of the ascertained body model parameters as body model parameters for the method for indirect length measurement in the memory of the computing unit. Preferably, the measurement points are targeted from different measurement positions. For example, the different measurement positions have different distances, different angles, different ratios of the distance to the additional distance, or the like. The embodiment according to the invention can advantageously minimize an error in the body model parameter.

Furthermore, a length measuring device is proposed for an indirect length measurement of an, in particular the aforementioned, distance between an, in particular the aforementioned, measurement point and an, in particular the aforementioned, additional measurement point, wherein the length measuring device comprises at least one, in particular the aforementioned, distance measuring device for detecting an, in particular the aforementioned, distance of the distance measuring device from the measurement point in an, in particular the aforementioned, measurement position of the distance measuring device and an, in particular the aforementioned, additional distance of the distance measuring device from the additional measurement point in an, in particular the aforementioned, additional measurement position of the distance measuring device, at least one angle measuring device for detecting a change in position of the distance measuring device from the measurement position to the additional measurement position and at least one, in particular the aforementioned, computing unit for carrying out the method according to the invention of the measurement error method according to the invention and/or the calibration method according to the invention. The length measuring device preferably comprises a housing in which the computing unit is arranged. Particularly preferably, the distance measuring device is arranged in the housing. Alternatively, the distance measuring device is freely movable relative to the housing and comprises in particular a wired or wireless, in particular radio wave-based, communication unit for a data transfer to the computing unit. At least the distance measuring device, in particular the entire length measuring device, is configured to be easy to hold, in particular to be held with one hand. In particular, the distance measuring device, in particular the entire length measuring device, has a weight of less than 10kg, in particular less than 5 kg, preferably less than 2 kg. The term “computing unit” is understood in particular to mean a unit having an information input, information processing, and an information output. Advantageously, the computing unit comprises at least one processor, an, in particular the aforementioned, memory, additional electrical components, an operating program, regulating routines, control routines, and/or calculation routines. The components of the computing unit are preferably arranged on a common board and/or advantageously arranged within a common housing. The computing unit is in particular specifically programmed, configured and/or equipped to perform the method(s) according to the invention. The length measuring device preferably comprises the operating unit for operating the length measuring device by the user, in particular at least for triggering the distance measuring device. In particular, the user unit includes buttons and/or a touch screen. The operating unit is preferably arranged on the housing. In particular, the length measuring device comprises the output unit for an output of the ascertained distance and optionally the ascertained measurement error and/or the proposal for reducing the measurement error. The output unit comprises, for example, a display, lighting elements, in particular LEDs, a speaker, or the like. The output unit is preferably arranged on the housing. The angle measuring device is preferably immovably arranged relative to the distance measuring device, in particular for detecting a change in the orientation of the distance measuring device, preferably the entire length measuring device. For example, the angle measuring device comprises at least one inertial sensor, in particular a rotation rate sensor, for detecting the change in orientation of the distance measuring device. Preferably, the angle measuring device comprises at least two inertial sensors, to distinguish between the horizontal partial change in position and the vertical partial position change. Optionally, the angle measuring device comprises at least one acceleration sensor. As a result of the embodiment according to the invention, an advantageously precise and cost-efficient length measuring device can be provided.

The method according to the invention for indirect length measurement, the method according to the invention for ascertaining and outputting a measurement error, the method according to the invention for calibration, and/or the length measuring device according to the invention are not be limited to the application and embodiment described above. In particular, the method according to the invention for indirect length measurement, the method according to the invention for determining and outputting a measurement error, the method according to the invention for calibration and/or the length measuring device according to the invention can comprise a number of individual elements, components and units as well as method steps different from a number mentioned herein for fulfilling a mode of operation described herein. Moreover, regarding the ranges of values indicated in this disclosure, values lying within the limits specified hereinabove are also intended to be considered as disclosed and usable as desired.

### DRAWINGS

Further advantages will emerge from the following description of the drawings. The drawings show an exemplary embodiment of the invention. The drawings, the description, and the claims contain numerous features in combination. The person skilled in the art will appropriately also consider the features individually and combine them into additional advantageous combinations.

Shown are:

FIG. 1 a schematic diagram of a length measuring device according to the invention,

FIG. 2 an additional schematic representation of the length measuring device according to the invention,

FIG. 3 a schematic flow chart of a method according to the invention,

FIG. 4 a schematic drawing for illustrating a method according to the invention for indirect length measurement,

FIG. 5 a schematic geometrical model of indirect length measurement,

FIG. 6 a schematic flow chart of a method according to the invention for determining and outputting a measurement error,

FIG. 7 a schematic flow chart of a method for calibration according to the invention,

FIG. 8 a schematic drawing for illustrating the method for calibration according to the invention, and

FIG. 9 to FIG. 11 schematic representations of an output of a result of the method according to the invention for indirect length measurement and/or the method according to the invention for determining and outputting a measurement error

### DESCRIPTION OF THE EXEMPLARY EMBODIMENT

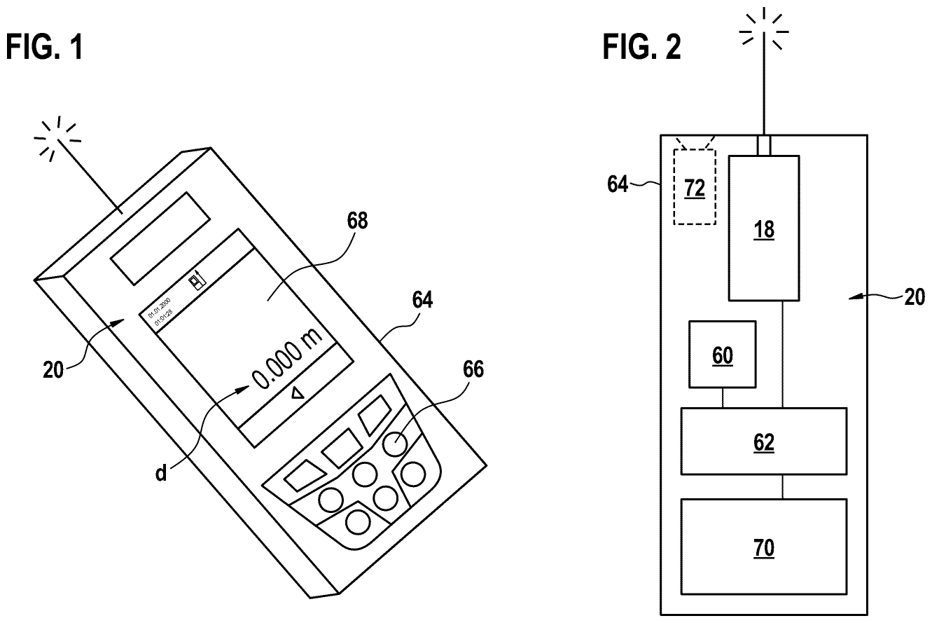

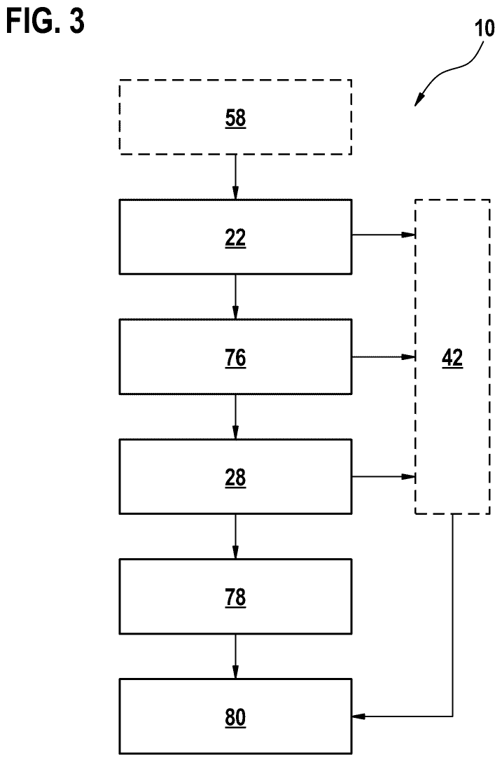

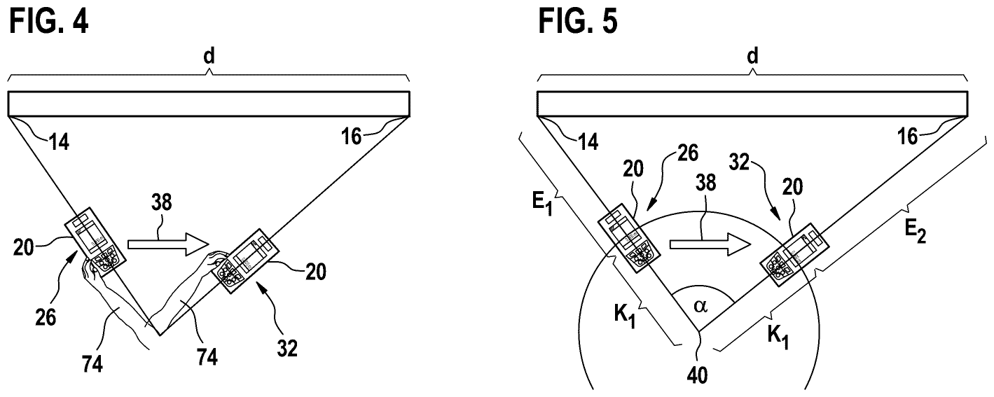

FIGS. 1 and 2 show a length measuring device 20. In particular, FIG. 1 shows an exterior view of the length measuring device 20 and FIG. 2 shows an interior view of the length measuring device 20. The length measuring device 20 is provided for an indirect length measurement of a distance d between a measurement point 14 and an additional measurement point 16 (see FIGS. 4 and 5). The length measuring device 20 includes a distance measuring device 18, in particular a laser distance measuring device. The laser distance measuring device is particularly provided to generate a green, a red or another laser beam for a time-of-flight. The distance measuring device 18 is provided for detecting a distance E₁ of the distance measuring device 18 from the measurement point 14 in a measurement position 26 of the distance measuring device 18 (see FIGS. 4 and 5). The distance measuring device 18 is provided for detecting an additional distance E₂ between the distance measuring device 18 and the additional measurement point 16 in an additional measurement position 32 of the distance measuring device 18 (see FIGS. 4 and 5). The length measuring device 20 includes at least one angle measuring device 60. The angle measuring device 60 is provided for detecting a change in position 38 of the distance measuring device 18 from the measurement position 26 to the additional measurement position 32 (see FIGS. 4 and 5). The length measuring device 20 includes at least one computing unit 62. The control unit 62 is provided for carrying out a method 10, which is explained in more detail in FIGS. 3 to 5. In particular, the length measuring device 20 comprises a housing 64. The computing unit 62, the distance measuring device 18 and/or the angle measuring device 60 are preferably arranged in the housing 64. The housing 64 can preferably be held with one hand, in particular a single, hand. Optionally, the housing 64 includes at least one gripping surface. In particular, the length measuring device 20 comprises a control unit 66. In particular, the operating unit 66 comprises at least one button, preferably a plurality of buttons. The operating unit 66 is in particular provided for a user input of data and/or triggering of the distance measuring device 18. The operating unit 66 is preferably arranged on the housing 64. The length measuring device 20 preferably comprises an output unit 68. In particular, the output unit 68 comprises a display to show the distance d. ascertained with the indirect length measurement. The output unit 68 is preferably arranged on the housing 64, in particular on a same side of the housing 64 as the operating unit 66. Preferably, the length measuring device 20 comprises at least one power supply 70 for providing electrical energy. The power supply 70 can, for example, be configured as an accumulator or as a battery compartment. Optionally, the length measuring device 20 comprises a camera unit 72. The camera unit 72 is particularly provided to detect a measurement object and to present an image of the measurement object on the output unit 68. Preferably, the image of the measurement object is superposed with a representation of a point of the measurement object that is targeted by the distance measuring device 18 at the time the image is displayed.

FIG. 3 shows a flow chart of the method 10. A geometric representation of method 10 is shown in FIGS. 4 and 5. The method 10 is for the indirect length measurement of the distance d between the measurement point 14 and the additional measurement point 16 by means of the distance measuring device 18 of the length measuring device 20 that can be held in the hand. The method 10 comprises at least one measurement step 22 in which the distance measuring device 18 detects the distance E₁ between the distance measuring device 18 and the measurement point 14 in the measurement position 26 of the distance measuring device 18. The method 10 preferably comprises an angle detection 76 in which the angle measuring device 60 detects a change in position 38 of the distance measuring device 18. The method 10 comprises at least one additional measurement step 28 in which the distance measuring device 18 detects the additional distance E₂ between the distance measuring device 18 and the measurement point 16 in the additional measurement position 32 of the distance measuring device 18. The method 10 preferably comprises a computing step 78 in which the computing unit 62 calculates the distance d. Preferably, the computing unit 62 calculates the detected distance E₂, and the detected change in position 36 as a function of the detected distance E₁. In the computing step 78, the computing unit 62 ascertains the distance d between the measurement point 14 and the additional measurement point 16 as a function of at least one body model parameter K₁ of a user of the length measuring device 20. The method 10 preferably comprises an output step 80. In the output step 80, the output unit 68 in particular outputs the ascertained distance d. Optionally, the method 10 comprises a calibration method 58 as a partial method, which ascertains the body model parameter K₁. Optionally, the method 10 comprises a measurement error method 42 as a partial method, which calculates a measurement uncertainty of the ascertained distance d.

FIG. 4 shows an indirect length measurement of the distance d with the length measuring device 20 during the method 10. The length measuring device 20 is held in the measurement position 26 during the measurement step 22, in particular by a user, here a user's arm 74 as an example. After detecting the distance E₁, the user targets another measurement point 16 with the distance measuring device 18. The distance measuring device 18 runs through the change in position 38 from the measurement position 26 to the additional measurement position 32. The change in position 38 may include a translation and/or rotation, and is in particular dependent upon a body dimension or body posture. In the example shown here, the user rotates the length measuring device 20 with the arm 74 extended from the shoulder.

FIG. 5 shows a geometrical model of the indirect length measurement shown in FIG. 4. In particular, the change in position 38 is modeled by the body model parameter K₁. The body model parameter K₁ is here, for example, a distance of a reference point of the length measuring device 20 from a pivot point 40. The pivot point 40 and the body model parameter K₁ are preferably selected such that the change in position 38 is described by a pure rotation about the pivot point 40, in particular without a translational portion. The reference point is in particular a zero point of the distance measuring device 18. The angle measuring device 60 preferably detects at least one angle α as the change in position 38. In particular, the detected angle α describes a change in an orientation of a reference axis, in particular a main direction of radiation, of the distance measuring device 18 by the change in position 38. Particularly preferably, the computing unit 62 ascertains the distance d by means of a trigonometric relationship between the detected variables and the distance d to be ascertained. By way of example, the computing unit 62 ascertains the distance d according to

$$d = {( {E}_{1} + {K}_{1} )}^{2} + {( {E}_{2} + {K}_{1} )}^{2} - ( ( {E}_{1} + {K}_{1} ) * ( {E}_{2} + {K}_{1} ) * cos ( α ) ) .$$

The body model parameter K₁ corrects the detected distance E₁ and/or the detected additional distance E₂ to ascertain the distance d between the measurement point 14 and the additional measurement point 16.

An additional body model parameter K₁ is used in at least one method step of the method 10, to correct the detected distance E₁ and/or the detected additional distance E₂, wherein a selection of which body model parameter K₁ is used and/or to what proportion the body model parameters K₁ are used, is dependent on a detection of a change in position 38 of the distance measuring device 18 from the measurement position 26 to the additional measurement position 32. Particularly preferably, the angle measuring device 60 detects a horizontal projection of the angle α and a vertical projection of the angle α, wherein in particular the horizontal projection of the body model parameters K₁ and the vertical projection of the additional body parameter are associated.

In at least one method step of method 10, a pivot point 40, which describes a change in position 38 of the distance measuring device 18 from the measurement position 26 to the additional measurement position 32 and from which the body model parameter K₁ is dependent, is selected. For example, in the computing step 78, the computing unit 62 asks the user how the user moved during the change in position 38, in particular which joints the user mainly used. In particular, the computing unit 62 selects the pivot point 40 and the associated body model parameter K₁ from a list of values stored in a memory of the computing unit 62, depending on the joints used.

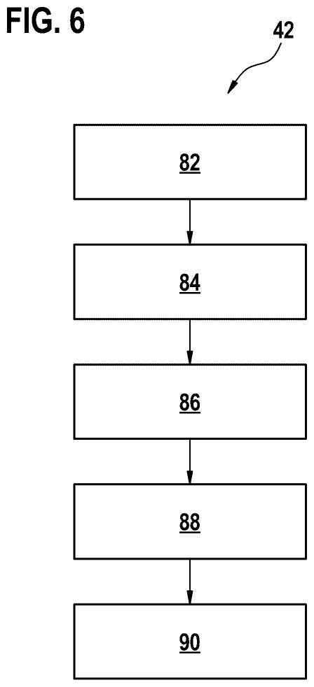

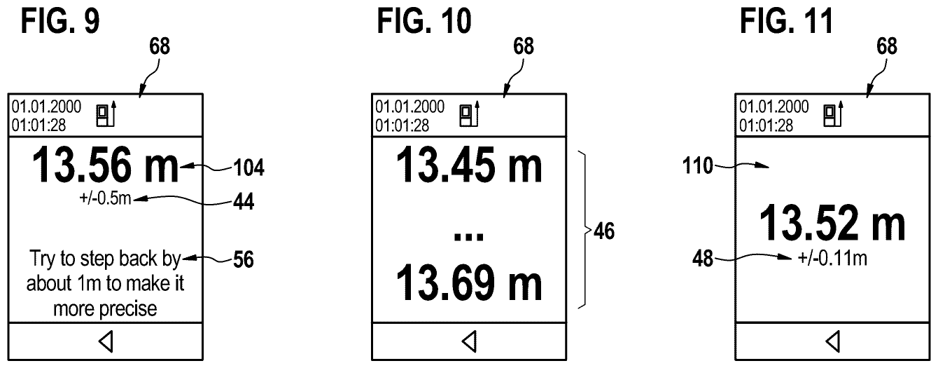

FIG. 6 shows a flow chart of a method for ascertaining and outputting a measurement error 44, 46, 48 (see. FIGS. 9 to 11), referred to in short as the measurement error method 42. The measurement error 44, 46, 48 is provided for an indirect length measurement, in particular for an indirect length measurement according to the method 10. The measurement error method 42 may in particular be used as a partial method of method 10. In at least one method step of the measurement error method 42, the measurement error 44, 46, 48 is ascertained and output as a function of the body model parameter K₁ of a user of the length measuring device 20 used for the indirect length measurement. The measurement error method 42, in particular, includes a distance error step 82. In the distance error step 82 in particular, a distance measurement error of a detection of the distance E₁ is ascertained. The computing unit 62 preferably queries the distance measurement error from the distance measuring device 18. The distance error may be a margin of error or a measurement uncertainty of the distance measuring device 18. The measurement error method 42, in particular, includes an angle error step 84. In the angle error step 84, in particular, an angle measurement error of a detection of the change in position 38, in particular the angle α, is ascertained. The computing unit 62 preferably queries the angle measurement error from the angle measuring device 60. The angle measurement error may be an error limit or a measurement uncertainty of the angle measuring device 60. Preferably, the measurement error method 42 comprises an additional distance error step 86. In the additional distance error step 86 in particular, an additional distance measurement error of a detection of the additional distance E₂ is ascertained. The computing unit 62 preferably queries the additional distance measurement error from the distance measuring device 18. The additional distance error may be an error limit or a measurement uncertainty of the distance measuring device 18.

The measurement error method 42, in particular, includes a measurement error computing step 88. In the measurement error computing step 88, the computing unit 62 preferably ascertains the measurement error 44, 46, 48 of the distance d. The computing unit 62 calculates the measurement error 44, 46, 48, in particular as a function of the detected distance E₁, the detected additional distance E₂, the change in position 38, in particular the angle α, the body model parameter K₁, the distance measurement error, the additional distance measurement error, the angle measurement error, and/or an error of the body model parameter K₁. The error of the body model parameter K₁ is preferably ascertained upon a determination of the body model parameter K₁ and stored in the memory of the computing unit 62. The measurement error method 42 preferably includes a measurement error output step 90. In the measurement error output step 90, the output unit 68 preferably outputs the measurement error 44, 46, 48, in particular together with the distance d. In the measurement error output step 90, the output unit 68 outputs a proposal 56 as to how the measurement error 44, 46, 48 can be reduced. Preferably, the computing unit 62 compares the measurement error 44, 46, 48 with an error threshold value. Preferably, the output unit 68 outputs the proposal 56, in particular only if the ascertained measurement error 44, 46, 48 is greater than the error threshold value. The computing unit 62 preferably selects the proposal 56 from a list of proposals. Preferably, the proposal 56 is selected as a function of the distance measurement error, the additional distance measurement error, the angle measurement error, the error of the body model parameter K₁, and/or as a function of a ratio of the distance E₁, the additional distance E₂, the ascertained distance d, and/or the body control parameter K₁ relative to each other.

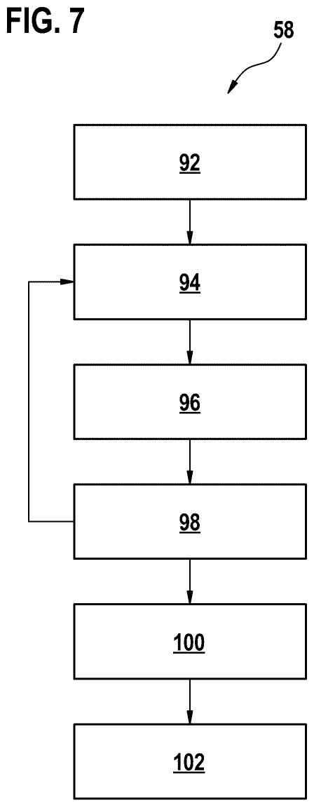

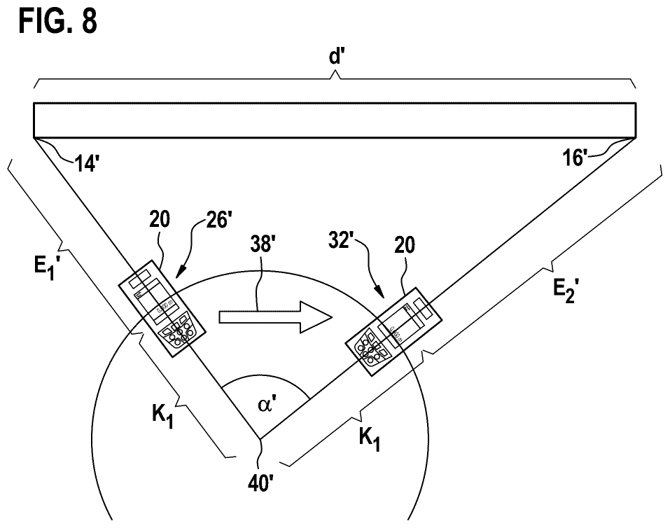

FIG. 7 shows a flow chart of a method for calibration of the handheld length measuring device 20 for an indirect length measurement, referred to in short as the calibration method 58. The calibration method 58 may in particular be used as a partial method of method 10. FIG. 8 shows a schematic diagram of the calibration method 58. In at least one method step of the calibration method 58, the body model parameter K₁ of a user of the length measuring device 20, and in particular the error of the body model parameter K₁, is ascertained. The body model parameter K₁ is ascertained by indirect length measurement of a known distance d′ between two measurement points 14′, 16′. The calibration method 58 includes, in particular, a calibration path determination 92. In the calibration path determination 92, the user detects the known path d′ by means of a length measuring device different from the length measuring device 20. In particular, the user may enter the known travel path d′ into the length measuring device 20 or may receive instruction from the length measuring device 20 as to how to ascertain the known travel path d′. The calibration method 58 preferably includes a calibration measurement step 94. The calibration measurement step 94 is the same as the measurement step 22 of method 10. In particular, the distance measuring device 18 detects a distance E₁′ of the distance measuring device 18 from the measurement point 14′. The calibration method 58 preferably includes a calibration angle detection 96. The calibration angle detection 96 is in particular the same as the angle detection 76 of the method 10. In particular, the angle measuring device 60 detects a change in position 38′, in particular as the angle α′, of the distance measuring device 18 from the measurement point 14′ to the additional measurement point 16′. In particular, the calibration method 58 includes an additional calibration measurement step 98. The additional calibration measurement step 98 is the same as the additional measurement step 28 of method 10. In particular, the distance measuring device 18 detects a distance E₂′ of the distance measuring device 18 from the measurement point 16′.

The calibration method 58 preferably includes a calibration computing step 100. In the calibration computing step 100, the computing unit 62 preferably ascertains the body model parameter K₁ as a function of the known distance d′, the detected distance E₁′, the detected additional distance E₂′ and the detected change in position 38′, in particular the angle α′. For example, the computing unit 62 ascertains the body model parameter K₁ using the computational procedure for the distance d stated above. The body model parameter K₁ is ascertained as a function of a plurality of detected values of the known distance d′. In particular, the computing unit 62 in the calibration computing step 100 forms a mean value or median of the detected values. In particular, in a memory step 102 of the calibration method 58, the computing unit 62 stores the ascertained body model parameter K₁, in particular the mean value or median of the body model parameter K₁, in the memory of the computing unit 62.

FIG. 9 shows the output unit 68 with a display mode during the output step 80 and/or the measurement error output step 90. In particular, the output unit 68 outputs an output value 104 of the ascertained distance d. In particular, the output unit 68 outputs the measurement error 44 as an absolute value. In particular, the output unit 68 outputs the proposal 56 to reduce the measurement error 44.

FIG. 10 shows the output unit 68 with an additional display mode during the output step 80 and/or the measurement error output step 90. Preferably, a user may switch the display mode via the operating unit. In the additional display mode, the computing unit 62 adds the measurement error 46 to the ascertained distance d and in particular outputs a range of values for the ascertained distance.

FIG. 11 shows the output unit 68 with an additional display mode during the output step 80 and/or the measurement error output step 90. In particular, in the additional display mode, the output unit 68 outputs at least one assessment of the measurement error 48. In particular, the output unit 68 outputs at least one warning as to whether the measurement error 48 is above the error threshold value. For example, the output unit 68 displays a background 110 of a display of the output unit 68 in different colors or shades as a function of the measurement error 48. For example, the output unit 68 displays the background 110 in red if the measurement error 48 is above the error threshold value. For example, the output unit 68 displays the background 110 in yellow if the measurement error 48 is below the error threshold value and above an additional error threshold value. For example, the output unit 68 displays the background 110 in green if the measurement error 48 is below the error threshold value and in particular below the additional error threshold value.

1. A method for the indirect length measurement of a distance between a measurement point and an additional measurement point using a distance measuring device of a handheld length measuring device, comprising:
detecting, in at least one measurement step, a first distance between the distance measuring device and the measurement point in a measurement position of the distance measuring device; and
detecting, in at least one additional measurement step, an additional distance between the distance measuring device and the additional measurement point in an additional measurement position of the distance measuring device, wherein in at least one method step, the distance between the measurement point and the additional measurement point is ascertained as a function of at least one body model parameter of a user of the distance measuring device.

2. The method according to claim 1, wherein the at least one body model parameter is used to correct the detected first distance and/or the detected additional distance to ascertain the distance between the measurement point and the additional measurement point.

3. The method according to claim 1, wherein:
at least one additional body model parameter is used, to correct the detected first distance and/or the detected additional distance; and
a selection of which of the body model parameters is used and/or to what extent the body model parameters are used, is dependent on a detection of a change in position of the distance measuring device from the measurement position to the additional measurement position.

4. The method according to claim 1, wherein, a pivot point describing a change in position of the distance measuring device from the measurement position to the additional measurement position and on which the at least one body model parameter is dependent is selected.

5. The method according to claim 1, wherein a measurement error is ascertained and output as a function of the at least one body model parameter of the user of the distance measuring device.

6. The method according to claim 5, wherein a proposal as to how the measurement error can be reduced is output.

7. A method for calibrating a handheld length measuring device for an indirect length measurement according to a claim 1, wherein the at least one body model parameter of the user of the length measuring device is ascertained.

8. The method according to claim 7, wherein the at least one body model parameter is ascertained by indirect length measurement of a known distance between two measurement points.

9. The method according to claim 8, wherein the at least one body model parameter is ascertained as a function of a plurality of ascertained values of the known distance.

10. A length measuring device for an indirect length measurement of a distance between a measurement point and an additional measurement point, comprising:
at least one distance measuring device configured to detect a first distance between the distance measuring device and the measurement point in a measurement position of the distance measuring device, and an additional distance of the distance measuring device from the additional measurement point in an additional measurement position of the distance measuring device, the at least one distance measuring device including at least one angle measuring device configured to detect a change in position of the at least one distance measuring device from the measurement position to the additional measurement position, and having at least one computing unit configured to perform the method according to claim 1.
